(19) United States
(12) Patent Application Publication
(10) Pub. No.: US 2003/0067844 A1
(43) Pub. Date: Apr. 10, 2003

(54) System and method of updating local time in different time zones

(76) Inventor: Kuo-Ming Liaw, Taipei (TW)

Correspondence Address: SAWYER LAW GROUP LLP, P.O. Box 51418, Palo Alto, CA, 94303, US

(21) Appl. No.: 10/192,219

(22) Filed: Jul. 9, 2002

(30) Foreign Application Priority Data
Oct. 4, 2001 (TW) 90124481

(51) Int. Cl. G04C 11/02

(52) U.S. Cl. 368/47; 368/21

(57) ABSTRACT

A system and a method of updating different local time in different time zones are proposed. The system is provided with an automatic time update transmitting module resident in a transmitting unit of a base station, and a portable electronic device for receiving a local time signal generated from the automatic time update transmitting module. When a user having the portable electronic device is situated within a range covered by the base station, the portable electronic device automatically receives the local time signal from the automatic time update transmitting module, so as to display local time in a time zone where the base station is located, and to simultaneously display original local time of a time zone where the user originally resides.

### CROSS-REFERENCE TO RELATED APPLICATION(S)

This application claims benefit under 35 USC 119 of corresponding Taiwan Application Serial No. 90124481 filed Oct. 4, 2001.

### FIELD OF THE INVENTION

The present invention relates to systems and methods of updating local time in different time zones, and more particularly, to a system and a method for automatically updating local time in a time zone different from an original time zone where a user resides, and simultaneously displaying local time in the original time zone.

### BACKGROUND OF THE INVENTION

With development of electronic and communication technology, many portable low-profile electronic devices with timing functions are getting more widely used, such as mobile phone, personal digital assistant (PDA) and handheld personal computer (HPC).

In the use of the above electronic devices or other artificial timing devices such as a watch or clock, for example, when local time in the surroundings is changed in the case of a user traveling to a country in a different time zone, the user needs to manually update time displayed in the electronic or timing device. Such a manual time-adjusting method is thus very inconvenient in operation for users who regularly travel among different countries. Moreover, once the user cannot be instantly informed of updated local time in different time zones, he or she may miss important appointments or delay schedules thereof.

Therefore, in response to the above drawbacks, how to provide a method for automatically updating local time in different time zones, is a critical problem to solve.

### SUMMARY OF THE INVENTION

A primary objective of the present invention is to provide a system and a method of updating local time in different time zones, whereby a user can be automatically informed of updated local time in different time zones and original local time of a time zone where the user originally resides simultaneously.

In accordance with the above and other objectives, the present invention proposes a system and a method of updating local time in different time zones.

The system of updating local time in different time zones of the invention, comprises: a base station having a transmitting unit, wherein an automatic time update transmitting module is established in the transmitting unit, and periodically transmits a signal of indicating local time in a time zone where the base station is located; and a portable electronic device having an antenna for receiving the local time signal from the automatic time update transmitting module.

The portable electronic device comprises: a receiving unit connected to the antenna, allowing the local time signal to be forwarded from the antenna to the receiving unit; a microprocessor connected to the receiving unit, allowing the local time signal to be forwarded from the receiving unit to the microprocessor for signal processing; a displaying unit connected to the microprocessor and for receiving the processed local time signal from the microprocessor, so as to display the local time of the base station; and a timing unit connected to the displaying unit and for calculating original local time of a time zone where the portable electronic device originally resides, so as to transmit the original local time to the displaying unit for display.

The method of updating local time in different time zones of the invention, is implemented through the use of the above time-updating system, and comprises the steps of: (1) periodically transmitting via the automatic time update transmitting module a signal of indicating local time in a time zone where the base station is located; (2) automatically receiving the local time signal from the automatic time update transmitting module via the antenna of the portable electronic device when a user with the portable electronic device is situated within an electromagnetic range covered by the base station; (3) forwarding the received local time signal from the antenna to the receiving unit; (4) converting the local time signal via a digital module of the receiving unit into a digital local time signal, and forwarding the digital local time signal to the microprocessor; (5) updating a digital local time signal stored in a signal storing unit via a signal updating module of the microprocessor with the digital local time signal received from the receiving unit; (6) storing the updated digital local time signal in the signal storing unit; (7) reproducing the updated digital local time signal stored in the signal storing unit via a signal reproducing and transmitting module of the microprocessor, and transmitting the reproduced digital local time signal to a signal converting module of the displaying unit; (8) converting the reproduced digital local time signal into a numeric format via the signal converting module, and displaying the numeric format on a first time display interface of the signal converting module; and (9) calculating via the timing unit original local time of a time zone where the user with the portable electronic device originally resides, and displaying the original local time on a second time display interface of the displaying unit.

By using the above system and method of the invention, a user can be automatically informed of updated local time in different time zones and original local time of a time zone where the user originally resides simultaneously.

### BRIEF DESCRIPTION OF THE DRAWINGS

The present invention can be more fully understood by reading the following detailed description of the preferred embodiments, with reference made to the accompanying drawings, wherein:

FIG. 1 is a structural schematic diagram showing a system of updating local time in different time zones of the invention; and

FIGS. 2a and 2b are continuous flowcharts as a whole showing process steps for a method of updating local time in different time zones through the use of the time-updating system of the invention.

### DETAILED DESCRIPTION OF THE INVENTION

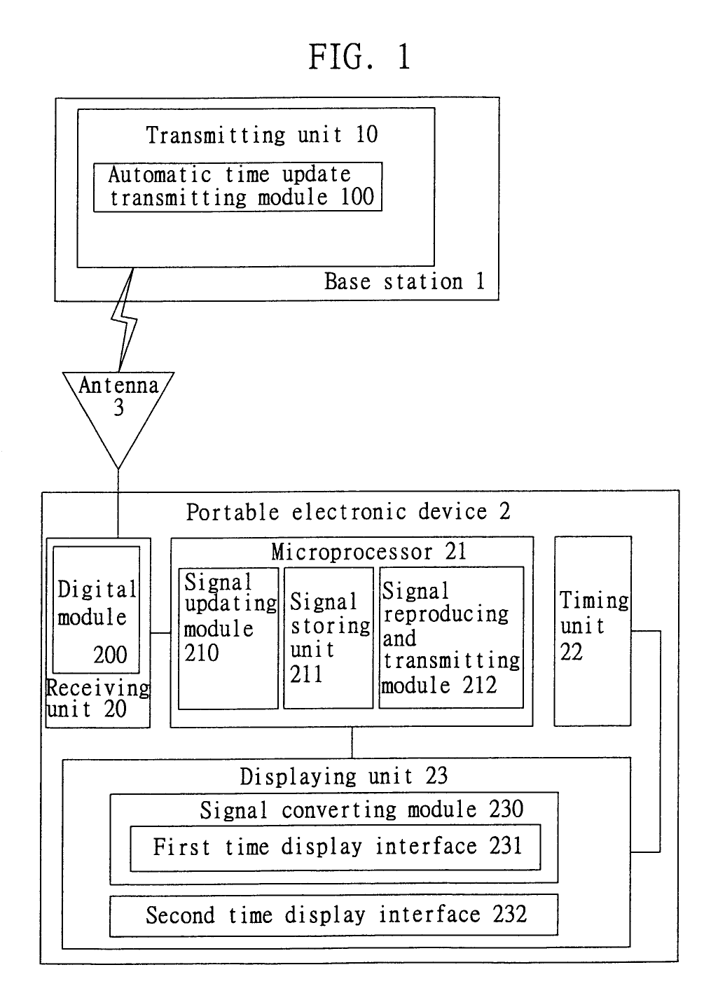

FIG. 1 illustrates structural configuration for a system of updating local time in different time zones (hereinafter abbreviated as “time-updating system”) of the present invention. As shown in the drawing, the time-updating system at least comprises: an automatic time update transmitting module 100, an antenna 3, and a portable electronic device 2. The automatic time update transmitting module 100, such as an automatic transmitting time program, is resident in a transmitting unit 10 of a base station 1. The transmitting unit 10 can be a transmitting program. The base station 1 may be a mobile phone base station, a TV base station or a broadcast base station in communication with the portable electronic device 2. The automatic time update transmitting module 100 periodically, for example, at intervals of 5 or 10 minutes or even every minute, generates a signal of indicating local time (hereinafter referred to as “local time signal”) in a time zone where the base station 1 is located.

The antenna 3 is connected to the portable electronic device 2, and adapted to receive the local time signal from the automatic time update transmitting module 100, allowing the received local time signal to be forwarded to the portable electronic device 2.

The portable electronic device 2 at least comprises: a receiving unit 20, a microprocessor 21, a timing unit 22, and a displaying unit 23. The receiving unit 20 further comprises a digital module 200. The microprocessor 21 further comprises a signal updating module 210, a signal storing unit 211, and a signal reproducing and transmitting module 212. The displaying unit 23 further comprises a signal converting module 230 having a first time display interface 231, and a second time display interface 232. The receiving unit 20 is connected to the antenna 3 and the microprocessor 21, and used to receive a local time signal from the base station 1, wherein the received local time signal is converted into a digital local time signal, and then forwarded to the microprocessor 21. The microprocessor 21 is connected to the displaying unit 23, for processing and transmitting the digital local time signal from the receiving unit 20 to the displaying device 23. The timing unit 22 can be a real time clock (RTC) that is conventional in the art and not to be further described herein. The timing unit 22 is connected to the displaying device 23, and adapted to calculate original local time in a time zone where the portable electronic device 2 originally resides, allowing the calculated original local time to be forwarded to the displaying unit 23. The displaying unit 23 is connected to the microprocessor 21 and the timing unit 22, so as to convert the local time signal from the microprocessor 21 into a numeric format for display, and also to display the original local time of the portable electronic device 2 calculated by the timing unit 22.

In more detail, the digital module 200 is adapted to convert a local time signal of an electromagnetic form received by the receiving unit 20 into a digital local time signal. The signal updating module 210 is used for replacing a digital local time signal stored in the signal storing unit 211 with an updated digital local time signal transmitted from the receiving unit 20 to the microprocessor 21, allowing the digital local time signal stored in the signal storing unit 211 to be updated. The signal storing unit 211 is adapted to store the updated digital local time signal. The signal reproducing and transmitting module 212 reproduces the updated digital local time signal stored in the signal storing unit 211, and transmits the reproduced digital local time signal to the displaying unit 23.

The signal converting module 230 converts the reproduced digital local time signal from the signal reproducing and transmitting module 212, into a numeric format to be displayed on the first time display interface 231. The second time display interface 232 is adapted to display the original local time from the timing unit 22.

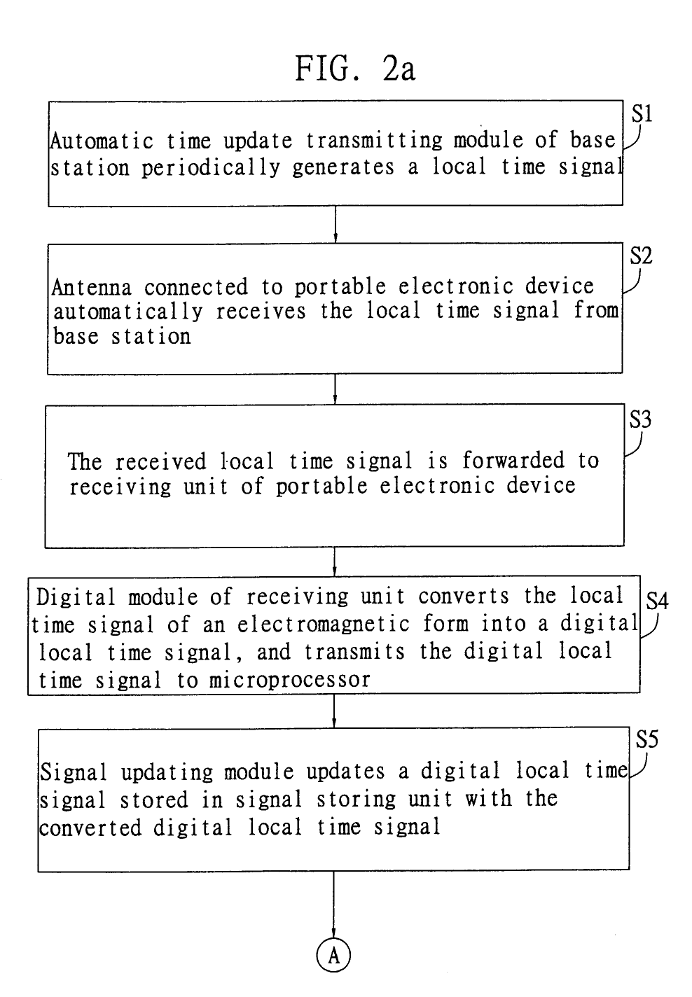

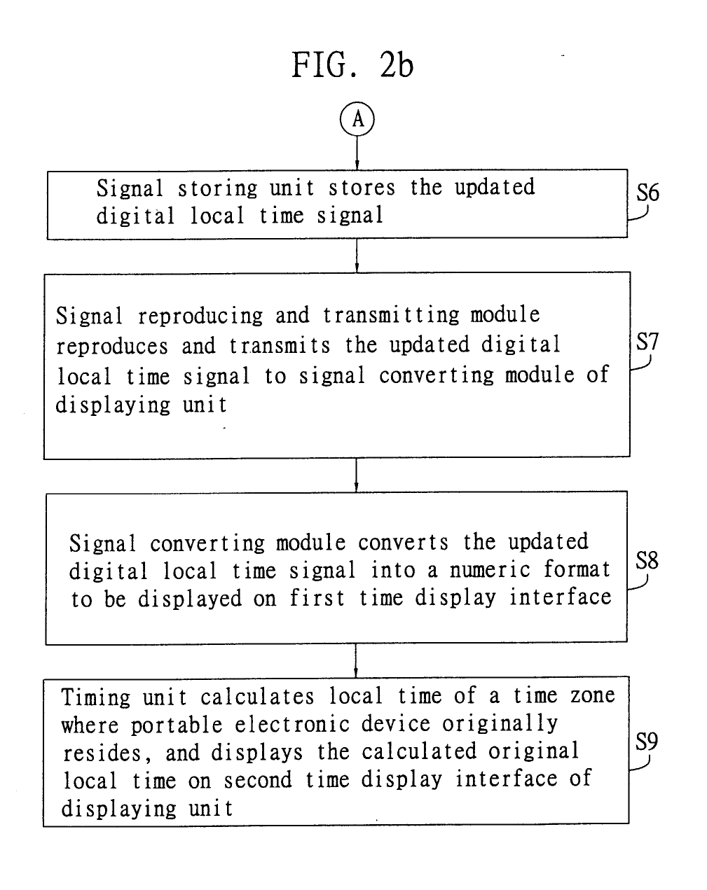

FIGS. 2a and 2b illustrate process steps for a method of updating local time in different time zones through the use of the time-updating system of the invention. As shown in drawings, in step S1, the automatic time update transmitting module 100 of the base station 1 periodically, for example, at intervals of 5 or 10 minutes or even every minute, generates a signal of indicating local time (hereinafter referred to as “local time signal”) in a time zone where the base station 1 is located.

In step S2, when a user having the portable electronic device 2 is situated within an electromagnetic range covered by the base station 1, the antenna 3 connected to the portable electronic device 2 automatically receives the local time signal from the base station 1.

In step S3, the local time signal received via the antenna 3 is forwarded to the receiving unit 20 of the portable electronic device 2.

In step S4, the digital module 200 of the receiving unit 20 converts the local time signal of an electromagnetic form into a digital local time signal to be forwarded to the microprocessor 21.

In step S5, the signal updating module 210 replaces a digital local time signal stored in the signal storing unit 22 with the digital local time signal received from the receiving unit 20, so as to update the digital local time signal stored in the signal storing unit 22.

In step S6, the signal storing unit 211 stores the updated digital local time signal.

In step S7, the signal reproducing and transmitting module 212 reproduces the updated digital local time signal stored in the signal storing unit 211, and transmits the reproduced digital local time signal to the signal converting module 230 of the displaying unit 23.

In step S8, the signal converting module 230 converts the reproduced digital local time signal into a numeric format that is to be displayed on the first time display interface 231. Thereby, the first time display interface 231 can promptly indicate updated local time of the base station 1.

In step S9, the timing unit 22 calculates original local time in a time zone where the user having the portable electronic device 2 originally resides, and transmits the calculated original local time to the second time displaying interface 232 of the displaying unit 23 for display.

As the time-updating system of the invention can be applied to any portable electronic device with a timing function, when a user travels among different time zones, the electronic device would be automatically updated with local time in a time zone where the user is currently situated, and also simultaneously display original local time of a time zone where the user originally resides.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system of updating local time in different time zones, comprising:
a base station having a transmitting unit, wherein an automatic time update transmitting module is established in the transmitting unit, and periodically transmits a signal of indicating local time in a time zone where the base station is located; and
a portable electronic device having an antenna for receiving the local time signal from the automatic time update transmitting module; the portable electronic device comprising:
a receiving unit connected to the antenna, allowing the local time signal to be forwarded from the antenna to the receiving unit;
a microprocessor connected to the receiving unit, allowing the local time signal to be forwarded from the receiving unit to the microprocessor for signal processing;
a displaying unit connected to the microprocessor and for receiving the processed local time signal from the microprocessor, so as to display the local time of the base station; and
a timing unit connected to the displaying unit and for calculating original local time of a time zone where the portable electronic device originally resides, so as to transmit the original local time to the displaying unit for display.

2. The system of claim 1, wherein the automatic time update transmitting module is an automatic transmitting time program.

3. The system of claim 1, wherein the transmitting unit is a transmitting program.

4. The system of claim 1, wherein the base station is a mobile phone base station, a TV base station, or a broadcast base station.

5. The system of claim 1, wherein the receiving unit has a digital module for converting the local time signal into a digital local time signal.

6. The system of claim 5, wherein the microprocessor has a signal updating module, a signal storing unit, and a signal reproducing and transmitting module.

7. The system of claim 6, wherein the signal updating module is adapted to update a digital local time signal stored in the signal storing unit with the digital local time signal transmitted from the receiving unit to the microprocessor.

8. The system of claim 7, wherein the signal storing unit is adapted to store the updated digital local time signal.

9. The system of claim 8, wherein the signal reproducing and transmitting module is adapted to reproduce the updated digital local time signal stored in the signal storing unit, and transmit the reproduced digital local time signal to the displaying device.

10. The system of claim 1, wherein the timing unit is a real time clock.

11. The system of claim 9, wherein the displaying unit has a signal converting module with a first time display interface, and a second time display interface.

12. The system of claim 11, wherein the signal converting module is adapted to convert the reproduced digital local time signal from the signal reproducing and transmitting module into a numeric format, and display the numeric format on the first time display interface.

13. The system of claim 11, wherein the second time display interface is adapted to display the original local time calculated by the timing unit.

14. A method of updating local time in different time zones, applied to a time-updating system, wherein the time-updating system includes a base station having an automatic time update transmitting module, and a portable electronic device having an antenna for wireless communication with the base station; the method comprising the steps of:
(a) periodically transmitting via the automatic time update transmitting module a signal of indicating local time in a time zone where the base station is located;
(b) automatically receiving the local time signal from the automatic time update transmitting module via the antenna of the portable electronic device when a user with the portable electronic device is situated within an electromagnetic range covered by the base station;
(c) forwarding the received local time signal from the antenna to a receiving unit of the portable electronic device;
(d) converting the local time signal via a digital module of the receiving unit into a digital local time signal, and forwarding the digital local time signal to a microprocessor of the portable electronic device;
(e) updating a digital local time signal stored in a signal storing unit via a signal updating module of the microprocessor with the digital local time signal received from the receiving unit;
(f) storing the updated digital local time signal in the signal storing unit;
(g) reproducing the updated digital local time signal stored in the signal storing unit via a signal reproducing and transmitting module of the microprocessor, and transmitting the reproduced digital local time signal to a signal converting module of a displaying unit of the portable electronic device;
(h) converting the reproduced digital local time signal into a numeric format via the signal converting module, and displaying the numeric format on a first time display interface of the signal converting module; and
(i) calculating via a timing unit of the portable electronic device original local time of a time zone where the user with the portable electronic device originally resides, and displaying the original local time on a second time display interface of the displaying unit.

15. The method of claim 14, wherein the base station is a mobile phone base station, a TV base station, or a broadcast base station.

16. The method of claim 14, wherein the automatic time update transmitting module is an automatic time transmitting program.

17. The method of claim 14, wherein the timing unit is a real time clock.
